(19) United States
(12) Patent Application Publication
(10) Pub. No.: US 2020/0342029 A1
(43) Pub. Date: Oct. 29, 2020

(54) SYSTEMS AND METHODS FOR QUERYING DATABASES USING INTERACTIVE SEARCH PATHS

(71) Applicant: DataWalk Spólka Akcyjna, Wroclaw (PL)

(72) Inventor: Krystian Piecko, Herndon, VA (US)

(21) Appl. No.: 16/889,530

(22) Filed: Jun. 1, 2020

Related U.S. Application Data
(63) Continuation of application No. PCT/EP2018/083634, filed on Dec. 5, 2018.
(60) Provisional application No. 62/595,490, filed on Dec. 6, 2017.

(51) Int. Cl. G06F 16/901; G06F 16/904; G06F 16/9035; G06F 16/28; G06F 16/16

(52) U.S. Cl. CPC G06F 16/9024; G06F 16/904; G06F 16/168; G06F 16/288; G06F 16/9035

(57) ABSTRACT

A computing system or a method provides a user interface to perform data analysis in a relational database, comprising: (a) bringing an electronic device of a user in communication with a computer server comprising the relational database that stores data objects in a non-hierarchical manner, which electronic device comprises a user interface; (b) receiving a request from the user via the user interface to perform a task directed to at least a subset of the data objects; (c) generating filtering operations for the task, which filtering operations is stored in a memory unit and, upon execution, generates a filtered data set from the subset of the data objects; and (d) automatically generating a search path comprising a plurality of visual graphical elements on the user interface, and the visual graphical elements correspond to the one or more filtering operations.

### CROSS-REFERENCE

This application is a Continuation Application of International Application No. PCT/EP2018/083634, filed Dec. 5, 2018, which claims priority to U.S. Provisional Patent Application No. 62/595,490, filed Dec. 6, 2017, each of which is entirely incorporated herein by reference.

### BACKGROUND

A database is a data storage concept that has evolved for decades since the 1960s to address increasing difficulties in designing, building, and maintaining complex information systems (e.g., multi-user systems with a large amount of data). Another data storage concept directly related to the database is a database management system (DBMS), which enables the effective handling of databases. Although the terms, database and DBMS, define different entities, they may be inseparable; for example, the properties of a database may be determined by a supporting DBMS of the database. A DBMS may be a complex software system, such as a general-purpose DBMS (e.g., Oracle®, Microsoft® Structured Query Language (SQL) Server®).

In particular, three major DBMS approaches that are widely used in the industry to create and manage a database are relational databases, object databases, and graph databases.

A relational database can be a collection of data items organized as a set of formally described tables from which data can be accessed easily. A relational database may be created using the relational model. The software used in a relational database may be referred to as a relational database management system (RDBMS). An RDBMS may comprise a number of tables in which, for example, each table has its own primary key.

A problem with the relational database may be the complexity that arises when the relational database is created. It is generally important that defined relationships among the tables are correct and that each set of information is linked to its pair. Although less information has to be entered in total than with other database approaches, verifying that the points are set up correctly may be a time-consuming process. Furthermore, the relationships between the tables can become complicated when a relational database comprises numerous tables.

An object database (also referred to as object-oriented database management system or OODBMS) can be a database management system comprising information represented in the form of objects, such as the objects used in object-oriented programming. Object databases may be different from relational databases. In some instances, a broader database management system may comprise both object databases and relational databases.

An object database may store complex data and relationships between data directly, for example, without mapping to relational rows and columns, which may make object databases suitable for applications in which complex data may be encountered. Objects may have a many-to-many relationship and may be accessed by the use of pointers. Pointers may be linked to objects to establish relationships. Another benefit of an OODBMS may be that an OODBMS may be programmed with small procedural differences without affecting the entire system. This may be helpful for those organizations that use data relationships that are not entirely final or where there is a need to change these relationships to satisfy a new business requirement.

Disadvantages of object databases may include, for example, lower efficiency when data is complex and/or relationships are complex, that late binding may slow down access speed, data and operations being separated, low responsiveness to changes in problem space, and inadequate design for concurrent problems.

A hybrid object-relational database may be suitable for some applications. A client application may direct queries to an object server component to obtain data from data sources. An object server component may operate with an object definition component which may fulfill the queries. An object definition component may access an object definition database to obtain and use metadata, in the form of programmatic objects, about the location and structure of the data stored in the data sources. In some cases, an object manager component may, for example, work with the object definition component to edit and create new metadata or, via the object server component, create new instances of the data sources.

Graph databases may depart from traditional storage and definitions paradigms. Many software developers may be familiar with storing data in tabular form in a relational database. Such approaches may work well for some applications, but not for others. Relational databases, for example, may exhibit difficulties in scaling. Given that more and more of today's innovative applications may involve massive data processing, such large data processing requirements may expose a need for new approaches, such as graph databases. For example, tables (e.g., tables used in relational databases) may be difficult to implement in web-based environments. Since a web may be characterized more as a collection of pages that are hyperlinked, than identically-shaped rows in a gigantic table, a graph database may more closely align with present-day web architectures. In some cases, a graph, as known from mathematics, or as informally drawn or used by most engineers, may be a much more natural representation for data that is native to the web. Given that much of the data processed by today's innovative applications may exist elsewhere or in remote locations, and given that some applications may not own a substantial percentage of their own data, such as for some social feed aggregators, graph databases may be more suited than some other database models.

Current databases, such as ORACLE®, may provide for the use of an ALTER command. The process of modifying database structures may directly require locking a database structure that will be modified. There is also a related LOCK command that effectuates a freeze of a database structure for the time of modification, such as adding, searching for, or modifying records of a given table.

Some end-user database systems may make use of special scripts utilizing special triggers that may execute ALTER and/or LOCK commands automatically.

In some instances, an operation of adding a column to a database may lock a table. Further, an ALTER command may stop currently executing data processing tasks, such as transactions. This may render processing operations executing with varying number of parameters ineffective, and may potentially threaten the integrity of data gathering. Further, if data are collected very quickly, the size of a data buffer may be insufficient.

The use of the aforementioned commands in databases that are updated frequently may be problematic because such approaches may require the databases to stop certain services during each modification process. It may be beneficial to create a database system that does not require the stopping of one or more services when, for example, a new column is to be added to an existing table.

Drawbacks of known graph databases may include, for example, increased memory requirements and difficulties in presenting information to a user in a clear way. In some cases, where a few nodes have a large number of connections and most other nodes have fewer connections, graph databases may be designed to keep the nodes and their linked objects (references) as close as possible (e.g., in proximity); as a result, the graph databases may not be split, leading to inefficient data drilling. Further drawbacks of current database systems include the unavailability of extending databases in real time and difficulties in understanding how a complex database is designed.

At least for the disadvantages and fallbacks of the present techniques that have been described, there is a need to design and implement an efficient database model that is especially adapted to large scale databases, is easily scalable, and has reduced memory requirements in comparison to graph, relational or object-oriented databases.

Moreover, a typical database may contain hundreds or even thousands of data structures (e.g., tables, objects, and graphs). A user wanting to execute database queries on a complicated database with many related data structures may have to design specially tailored queries, which may be complex and require a long time to process by a computing machine. Oftentimes, the queried results may not reflect the desired results, necessitating the iterative re-design and re-processing of the queries may, which may be very costly in terms of time and processing capacity.

### SUMMARY

Recognized herein are various limitations to databases that are currently available, such as those described above. It may be advantageous to improve data query processes with an interactive data discovery and data visualization tool. Such a tool may be independent of a hierarchy of a database. For example, up to now, such data query processes may have been hardcoded in end-user software, such as Business Intelligence (BI) database software, Enterprise Resource Planning (ERP) database software, and Customer Relationship Management (CRM) database software.

In a traditional SQL-based system, a user seeking an answer may proceed through a series of queries. At each step, the query may become longer and more complex, and take longer to execute. With each incremental step, the assumptions in the query may become increasingly hidden (e.g., concealed) from the end user. Each step may require a SQL expert with knowledge of the underlying data representation. The focus with such systems may be concentrated on writing good queries. NoSQL databases or other well-known database languages may also share such problems with SQL-based systems.

Methods and systems of the present disclosure may allow a user to explore, mine, and/or analyze data objects by building search paths. A user may not need to be aware of the SQL queries (or NoSQL queries) which are being generated behind the scenes. The systems may provide a user interface to a user, and the user interface may direct the user along a path of inquiry. Each step can be incremental and fast. As a user creates a path, all of the previous steps may be visible to the user, and the assumptions may not be buried in, for example, an exceedingly long SQL query. If a path leads to a dead-end, a user may quickly and easily return to a previous step in the path and resume exploration from that point.

In a graph database, the focus may be on objects. For example, when a graph database satisfies a query, it does so using objects. In a typical graph database, many objects may have a handful of links to other objects, but a few objects may have a large number of links. When such graph database partitions a dataset to speed up queries, each object can be assigned to a partition. In the process, some partitions may be assigned objects with a large number of links. These partitions may run slowly and may delay the result of the entire query. In some instances, deployments using graph databases may manipulate the objects in an unnatural way to avoid these issues. However, by forcing the object model to fit the limitations of the graph database, other maintenance and usability issues may arise.

In contrast, systems of the present disclosure may be connection-oriented. An underlying relational database management system (RDBMS) may be optimized around connections (as opposed to objects). For example, when the RDBMS partitions data for performance, there is no need for an object to reside wholly within a single partition. In the disclosed system, the connections may be spread across all available compute resources. Consequently, even massively linked objects may be handled without the performance penalty issues in a traditional graph database.

In one aspect, disclosed herein is a method for performing data analysis in a relational database, comprising: (a) bringing an electronic device of a user in communication with a computer server comprising the relational database that stores data objects in a non-hierarchical manner, which electronic device comprises a user interface; (b) receiving a request from the user via the user interface to perform a task directed to at least a subset of the data objects; (c) generating one or more filtering operations for the task, which one or more filtering operations is stored in a memory unit and, upon execution, generates a filtered data set from the at least the subset of the data objects; and (d) automatically generating a search path comprising a plurality of visual graphical elements on the user interface, wherein at least one of the visual graphical elements corresponds to the one or more filtering operations performed on the at least the subset of the data objects.

In some embodiments, the one or more filtering operations comprise at least one of the following: filter on a property of a selected data object, filter on the number of selected relationships between selected data sets of the data objects, a complement operation of a previous filter operation, or select a subset of sorted search results. In some examples, the complement operation of a previous filter operation provides complementary search results of the previous filter operation.

In some embodiments, the at least one visual graphical element comprises options for determining a logical relationship of the one or more filtering operations. In some cases, the method further comprises updating the data analysis result in response to a change of the logical relationship of the one or more filtering operations.

In some embodiments, the method further comprises outputting the data analysis result in a histogram view or in a graph. In some cases, the graph comprises one or more nodes and one or more links representing the data sets of the data objects and relationships between the data sets. In some embodiments, the method further comprises updating the data analysis result in response to adding or removing a visual graphical element.

In some embodiments, the method further comprises storing the one or more operations and criteria then reproducing the data analysis result by applying the stored data analysis to the data objects.

In some embodiments, the non-hierarchical manner used to store data objects comprises defined fixed data structures, which comprise: a first data structure, stored in a memory, comprising a definition of data sets in the relational database, wherein a definition of a data set comprises a unique data set identifier and a set name; a second data structure, stored in the memory, comprising definitions of properties of objects in the relational database, wherein a definition of a property comprises a unique identifier of the property and a data set identifier, from the first data structure, the property is assigned to; a third data structure, stored in the memory, comprising definitions of objects of the data sets in the relational database, wherein a definition of an object comprises a unique object identifier and a data set identifier, from the first data structure, the object is assigned to; a fourth data structure, stored in the memory, comprising definitions of object values of the data sets in the relational database, wherein a definition of object value comprises an object identifier, from the third data structure, and a property of the data set, from the second data structure, the object value being assigned to; a fifth data structure, stored in the memory, comprising definitions of relations of data sets in the relational database, wherein a definition of a relation comprises a unique identifier of the relation and a name of the relation; and a sixth data structure, stored in the memory, comprising definitions of objects relations between the objects in the relational database, wherein a definition of an object relation associates a relation, from the fifth data structure, with two object identifiers from the third data structure. In some cases, the defined fixed data structures further comprise a seventh data structure, stored in the memory, comprising definitions of set relations between data sets in the relational database, wherein a definition of a set relation associates a relation, form the fifth data structure, with two set identifiers from the first data structure.

In a related yet separate aspect, a system for performing data analysis in a relational database is provided. The system may comprise: a relational database that stores data objects in a non-hierarchical manner; and one or more computer processors operatively coupled to the relational database, wherein the one or more computer processors are individually or collectively programmed to: (i) receive a request from a user via a user interface to perform a task directed to at least a subset of the data objects; (ii) generate one or more filtering operations for the task, which one or more filtering operations is stored in a memory unit and, upon execution, generates a filtered data set from the at least the subset of the data objects; and (iii) automatically generate a search path comprising a plurality of visual graphical elements on the user interface, wherein at least one of the visual graphical elements corresponds to the one or more filtering operations performed on the at least the subset of the data objects.

In some embodiments, the one or more filtering operations are selected from the group consisting of: filter on a property of a selected data object, filter on the number of selected relationships between selected data sets of the data objects, a complement operation of a previous filter operation, and select a subset of sorted search results. In some cases, the complement operation of a previous filter operation provides complementary search results of the previous filter operation.

In some embodiments, at least one of the visual graphical element comprises options for determining a logical relationship of the one or more filtering operations. In some embodiments, the one or more computer processors are programmed to further output search result in a histogram view or in a graph. In some cases, the graph comprises one or more nodes and one or more links representing the data sets of the data objects and relationships between the data sets.

In some embodiments, the one or more computer processors are programmed to further update search result in response to adding or removing a visual graphical element. In some embodiments, the one or more computer processors are programmed to further store the one or more filtering operations and criteria in the memory unit, wherein the criteria are inputted via the user interface. In some cases, the one or more computer processors are programmed to further reproduce a search result by applying the stored one or more filtering operations and criteria to the data objects.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “FIG.” and “FIGs.” herein).

FIG. 1 schematically shows two search paths comprising series of queries and/or operations.

FIG. 2 shows a new database system.

FIG. 3 shows an example of a database system of the present disclosure.

FIG. 4 depicts a mind map that may represent the database of FIG. 2 and FIG. 3.

FIG. 5 shows an exemplary model of a database system of the present disclosure.

FIG. 6 shows an example of a visualized database and the start of a breadcrumb.

FIG. 7 shows an example of performing a filter operation on a selected class and the associated breadcrumb.

FIG. 8 shows an example of determining multiple Entity Class Attributes and logical relationships in a breadcrumb.

FIG. 9 shows an example of a breadcrumb comprising filters on different entity classes or data sets.

FIGS. 10-13 show examples of breadcrumbs comprising filter operations on Entity Links or connections.

FIG. 14 shows an example of a breadcrumb.

FIG. 15 shows an example of a breadcrumb comprising a step analyzing a search result.

FIG. 16 shows an example of a breadcrumb comprising a step analyzing a search result.

FIG. 17 shows an exemplary histogram of a search result.

FIG. 18 shows a computer system that is programmed or otherwise configured to generate an interface for a search path or interactive breadcrumb.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

Systems and methods of the present disclosure may be visualization-oriented, which may enable a user to explore data sets simply by selecting (e.g., clicking) and filtering graphical elements. Interactions with a visualization system can generate a series of visible queries, enabling the system to be effectively operated by a user who has no knowledge of SQL or any specific database systems or languages. The visualization system may provide a user interface to a user, and the user interface may allow the user to explore a search path. Each step of the search path can be incremental from the previous step. Each step may generate fast results. As a user creates a search path, all or at least a portion of the previous steps of the search path may be visible to the user. The operation and/or filtering criteria associated with each step may be visible. If a path leads to a dead-end, a user may return to a previous step in the path and resume exploration from that point.

### Search Path

The present disclosure provides methods and systems for providing search paths from a first set of objects to a second set of objects. Search paths may be paths provided to users on a user interface, such as a graphical user interface (GUI).

A search path may comprise a sequence of high level queries and/or operations on at least a subset of objects in a database. A search path may also be referred to as a “breadcrumb.” A search path may be associated with an analysis. An analysis may comprise a search path and additional information about the analysis. Such additional information may include a name and description of the analysis and/or a name and description of a component of the search path. The search path may be generated and/or updated automatically when a user traverses one or more data objects in the database. The search path may be generated and/or updated automatically as the user performs operations on the data objects to investigate or explore the data. In some instances, the search path may be generated and/or updated in real-time.

Real-time can include a response time of less than 1 second, tenths of a second, hundredths of a second, or a millisecond. In some instances, real-time can refer to a simultaneous or substantially simultaneous timing of one process (e.g., visualization of search path) relative to another process (e.g., user exploration of data). All of the visualize processes described herein may be capable of happening in real-time.

The search path may comprise one or more high level queries and/or operations. The one or more high level queries and/or operations may be performed by a user. In some embodiments, a high level query on the objects in the database may be translated into a set of predefined queries such as relational database management system (RDBMS) structured query language (SQL) queries.

In some cases, the set of predefined queries may not be visible to a user. The set of predefined queries may be a set of optimized queries generated by the provided system upon receiving a high level query request from a user. The set of predefined queries may be optimized to improve query performance. For example, the set of predefined queries may be generated using horizontal and vertical partitioning strategies or server clustering techniques.

In some cases, a predefined query may be stored as a template query and comprise values of filtering criteria associated with the underlying objects. For instance, one template query can be used to retrieve an object and all of its properties, and another template query can be used to retrieve a list of objects that share a particular connection regardless of the underlying objects. These template queries can be used repetitively and applied to various different types of data objects.

The high level query may comprise filter operations on a set of objects, data objects, and/or connections between datasets. For example, a user may filter on a property of a selected data object, filter on the number of selected relationships between selected data sets, and/or filter on the type of connection between selected data sets.

In some embodiments, an operation can be any operation performed on objects in the database. The operation may be a filter or query operation performed on the data objects, as described above. The operation may be an analysis of a search result, such as a complementary operation of a previous filter operation that provides complementary search results of the previous filter operation. The operation may be a selection operation of a subset of sorted search results.

A search path may comprise a plurality of steps, or points. A step, or point, in a search path may be associated with an operation, as described elsewhere herein. The steps in a search path may be sequential. A subsequent step to a previous step may be cumulative, and incremental to the previous step. Visualization of the search path may comprise visualization of the sequence of the steps in the search path. A user may freely navigate from point to point in a generated search path.

For example, a user may return back to any prior point or step in a search path and create a different search path therefrom. This may be enabled by one or more configurations of the provided system. For example, the provided system may be configured to store one or more intermediate results of previous query executions, use a set of predefined query templates as described above, reuse saved search paths or series of operations, and/or store objects using a set of logical data structures. The set of logical data structures is described further elsewhere herein.

In some cases, the user may be able to return from a previous point to a subsequent point (e.g., already executed operation) in a search path. For example, during a search, a user may jump back to a previous point to view the intermediate results of the previous point, and return back to the latest point (or jump to a different subsequent point) to resume the search from the latest point.

In some cases, by saving the intermediate results of prior queries or operations, when a user jumps from point to point in a search path, the associated data queries at the different points may not need to be executed again. Instead, a cached copy of the previously generated results or data visualization may be redisplayed. In some embodiments, an intermediate result or search result may be stored in a table as a list of entity IDs.

One or more search paths, or operations of a search path, can be saved as a user explores connections between data sets and/or performs data analysis. The search path may represent an investigation path of a user who creates and answers questions as the user explores the data. When creating a search path, a user may select a starting data set, view the available connections from objects in the selected data set to other objects in a graphical user interface, and jump along one or more connections (i.e., perform a query on a connected data set via selecting one or more connections). Saving a series of operations or a full search path may allow a user to return to any point in the search path at a later time for further exploration. In some instances, a search path or a series of operations of a search path (i.e., partial search path) may be saved along with the respective search result that the search path reached. In some cases, the search result or intermediate search result may be saved in isolation. For example, the search path taken to reach the particular isolated search result may not be saved. This may be of benefit, for example, if the search path is particularly long or convoluted and saving the path provides little value to the user. Alternatively, the search result or intermediate search result may be saved together with the search path taken to reach the search result. In some embodiments, the system may provide an option for the user to choose whether a search result should be saved with or without the associated search path.

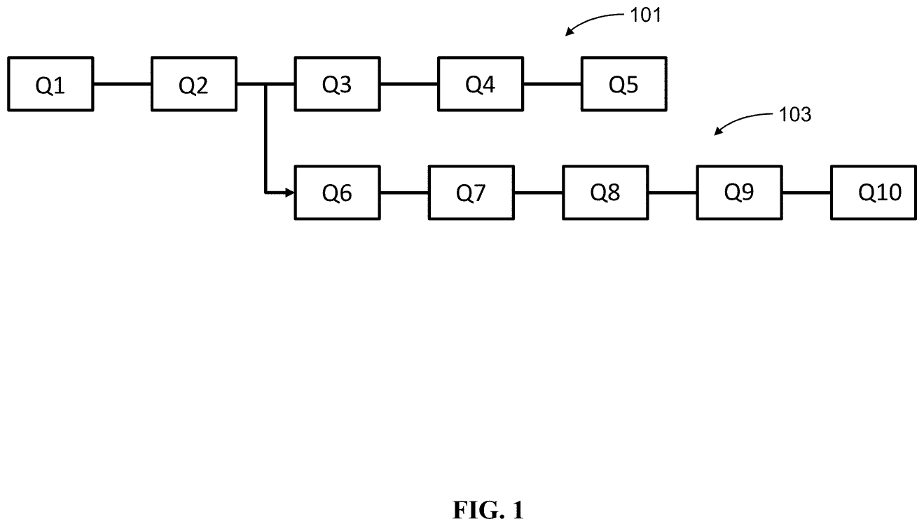

FIG. 1 schematically shows two search paths 101, 103 comprising series of queries and/or operations. As illustrated in the example, a search path 101 may be generated when a user performs a series of queries Q1, Q2, Q3, Q4, and Q5, on data objects or a subset of objects in the database. This analysis process may proceed over as many data set queries as the user wishes to investigate. The series of queries and/or operations may be applied to data objects of the same entity class or different entity classes. The series of queries and/or operations may also comprise filter operations on connections between entity classes and/or analysis of a search result, as described elsewhere herein. The provided system may allow a user to backtrack and create a new analysis or search path starting from any previous query or operation. For example, as illustrated in FIG. 1, a user may decide to branch from the search result of Q2, thereby forming a second search path or analysis 103 comprising a different series of queries or operations: Q1, Q2, Q6, Q7, Q8, Q9, and Q10.

As described above, a user may trace back to any prior point in a search path and create a different search path therefrom. This may be enabled by the provided system that is configured to retain (e.g., store in memory) the intermediate results of previous query executions in temporary tables, use a set of predefined query templates, utilize saved search paths or series of operations, and store objects using a set of logical data structures.

In some embodiments, the results of each step (e.g., Q1, Q2, Q3, Q4, Q5) in the search path may be stored in a temporary table. In an example, as the user performs queries in a search path, the system may be configured to execute a set of predefined queries against the underlying RDBMS, as described elsewhere herein. The result of the query may be a list of identifier IDs of the objects. The result may then be kept as one or more temporary tables in the database. When the user continues to explore the objects, such as by jumping along another connection, the same set of predefined queries or query templates may be executed again, and the temporary table(s) of the previous query may be used as a source table of the next query.

In another example, storing intermediate results along the search path in temporary tables may allow a user to explore unknown connections. For instance, at any point in investigating data objects and developing a search path, a user may try out various queries to explore what other objects are connected to the search path or other search directions at this point. In this case, the user may repetitively return back to the same point or any previous point for exploring possible or unknown relationship between objects. Such operations may not be supported by conventional SQL based data representations in which a user may only be allowed to access the final result of a SQL query.

Additionally, storing the results of each step along the search path may be beneficial for sharing the search results among different users or different projects, thereby speeding up an analysis. For instance, before a user begins exploring a new search path, the system may examine existing temporary results tables and the related search paths to see if any of them cover the new search path or at least the beginning of the new search path. If a matching temporary results table and/or search path is found, then the temporary results and/or search path may be used directly without having to execute the operations again, thereby reducing time for analysis and saving substantial processing. Shared and repetitive use of intermediate results among different users and/or projects may allow the system to perform analysis with faster response time.

The provided search path may permit exploring data objects and performing data analysis with improved performance. In some embodiments, the search path may be an interactive breadcrumb generated and provided to a user on a graphical user interface such that a user may modify and adjust one or more parameters or filter criteria by interacting with the breadcrumb directly. A breadcrumb may be interactive (“interactive breadcrumb”). A breadcrumb may comprise a search path. A breadcrumb may comprise one or more components of a search path.

In some embodiments, the breadcrumb may comprise a plurality of visual graphical elements on the user interface. The plurality of visual graphical elements may correspond to one or more queries and/or operations performed on at least a subset of objects in the database. In some embodiments, the one or more queries can be the same as the high level queries described elsewhere herein. The high level query may comprise filter operations on a set of objects, data objects, and/or connections between data sets. For example, a user may filter on a property of a selected data object, filter on the number of selected relationships between selected data sets, or filter on the type of connection between selected data sets. The one or more operations can be the same as the operations described elsewhere herein. The one or more operations may comprise filter operations and various other operations for further analyzing a search result. For example, a complementary operation may be applied to a previous filter operation that provides complementary search results of the previous filter operation. In another example, an operation of selecting a subset of sorted search results may be performed.

In some cases, a graphical element may correspond to a query on a set of objects. Each query may comprise one or more filter operations. In some cases, a graphical element may comprise a graphical representation of options for determining a logical relationship (e.g., AND, OR, XOR, etc) of multiple filtering operations. In some cases, a graphical element may correspond to an operation for a further analysis step or presenting step of a search result. A graphical element may correspond to a step in the search path. A step in a search path may be a query operation performed on at least a subset of objects in the database, a filter operation on connections between data sets, a selection of a data set, an analysis step on a search result, and/or various other operations. A step may correspond to one operation. A step may correspond to a plurality of operations.

In some embodiments, a graphical element may comprise icons or images indicative of a type of operation of the associated step. By way of example, a target icon may indicate that a target data set is selected, a funnel icon may indicate a filter operation on the selected data set, an arrow icon may indicate an operation of filtering by number of connections, and an arrow-over-funnel icon may indicate a filter operation by types of connections between selected data sets. It is not intended that the invention be limited by the specific examples provided within the specification, and various other images or icons (e.g., static images or dynamic images) can be used. The graphical element may be any graphical representation (e.g., an image, an icon, a video, a barcode, an optical signal, a graphic, etc.).

The interactive breadcrumb may allow a user to visualize any step, query, operation, intermediate search result, and/or filter criteria along the search path. In some embodiments, at least one of the operations can be modified or defined via the interactive breadcrumb directly. For instance, the logical relationship of multiple filtering operations may be specified or defined by a user by directly selecting an operation (e.g., AND, OR, XOR, etc) presented by the graphical elements of the search path. The breadcrumb may be presented to a user in any location on a display screen. For instance, the breadcrumb may be displayed on top of a graphical database view, a bottom bar, a left column, a right column, or in any other position. In some cases, each “crumb” in the breadcrumb may correspond to a graphical element as described elsewhere herein. In some embodiments, each crumb may be selectable or editable by a user. In some cases, each crumb may correspond to a step in the search path. Alternatively, a crumb may correspond to multiple steps in a search path.

As mentioned above, objects in the database may be organized and stored using a set of logical data structures. Such set of logical data structures may be based on a mind map. Storing objects in a database based on the mind map architecture allows a user to explore objects, and perform analysis by creating, modifying and storing one or more search paths with improved efficiency and flexibility. Database systems

A relational database of the present disclosure may be summarized as follows: there are at least two sets of elements and at least one relation that define how elements from a first set are related to elements of a second set. The relation may be defined in a data structure that maps elements of the first set to elements of the second set. Such mapping may be brought about with the aid of unique identifiers (within each set) of the elements in each set.

A relational database designer may find it challenging to describe real life events and entities on a very complex tables and relations diagram.

Real life events, however, may be suitably defined and presented with the aid of electronic mind maps (also referred to as “mind maps” herein).

In some embodiments, an electronic mind map is a diagram which may be used to visually outline and present information. A mind map may be created around a single object but may additionally be created around multiple objects. Objects may have associated ideas, words and concepts. In some instances, the major categories radiate from each node, and lesser categories are sub-branches of larger branches. Categories can represent words, ideas, tasks, or other items related to a central key word or idea.

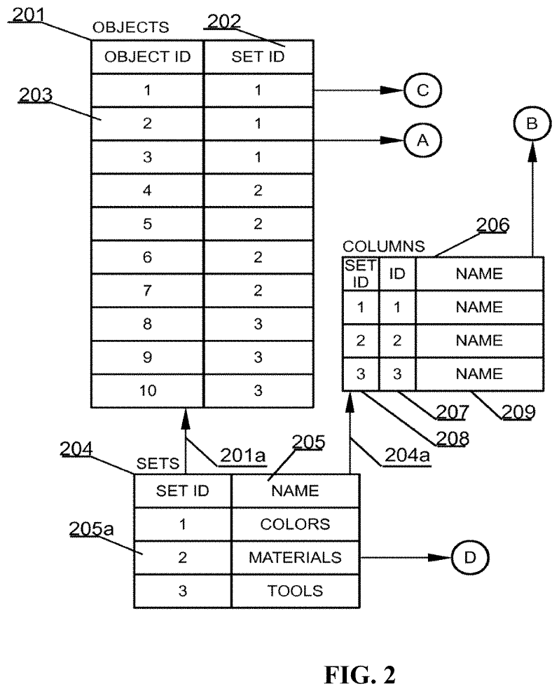

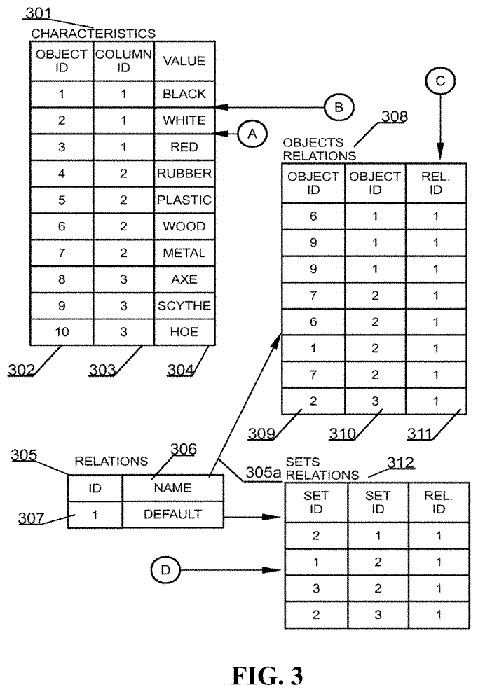

FIG. 2 and FIG. 3 show a new database system. In order to cooperate with mind maps, the database system has been designed differently than known database systems. The database system may comprise six core data structures and optional data structures. The core data structures may comprise SETS 204, OBJECTS 201, COLUMNS 206, CHARACTERISTICS 301, RELATIONS 305 and OBJECTS RELATIONS 308. It should be noted that the names above are exemplary only and the respective core sets are defined rather by their function within the system than their name.

The first data structure is called SETS 204 because it may be used to logically hold data related to sets of data. Sets of data may be represented on a mind map as nodes. Each entry in a SETS data structure 204 may comprise at least a unique identifier 205a of a data set and may also comprise a name 205 of the data set. The SETS data structure may be a top level structure and may not refer to other data structures, but other data structures may refer to the SETS data structure as identified by respective arrows between the data structures of FIG. 2.

Each set of data may be, as in the real world, characterized by one or more properties. The second data structure may be called COLUMNS 206. A property, typically referred to as a “column,” may be uniquely identified with an identifier ID 207 and may be associated with a data set, defined in the SETS data structure 204, with the aid of an identifier herein called SET ID 208. A column may also be associated with a name 209. As indicated by an arrow 204a, the COLUMNS data structure may logically, directly reference the SETS data structure 204, because the COLUMNS data structure may utilize the identifiers of data sets. If, for example, each color of the data set called COLORS comprises another property, such as RGB value, an exemplary entry in the COLUMNS data structure may comprise the following values: ‘1, 4 , RGB’. Referring back to an example from FIG. 2, there may be three columns wherein each column is associated with a textual identifier “NAME” 209.

Objects may form elements of respective data sets in the SETS 204 data structure and may have properties defined by the COLUMNS 206 data structure. Objects may be held in the OBJECTS 201 data structure. The OBJECTS 201 data structure may hold entries uniquely identified with an identifier ID 203 and associated with a set, defined in the SETS data structure 204, with the aid of an identifier herein called SET ID 202. As indicated by an arrow 201a, the OBJECTS data structure may logically, directly reference the SETS data structure, as, for example, the SETS data structure utilizes identifiers of sets. Referring back to an example from FIG. 2, there are ten objects in the database, namely three colors, four materials, and three tools. Hence, the OBJECTS data structure 201 may comprise ten objects.

A fourth core data structure, identified as CHARACTERISTICS 301 in FIG. 3, may hold data entries of each property of each object in FIG. 3. This data structure may be a fundamental difference from known databases in which there are rows of data that comprise entries for all columns of a data table. In the present disclosure, each property of an object is stored as a separate entry, which may greatly improve scalability of the system and allow, for example, the addition of object properties in real time.

The CHARACTERISTICS 301 data structure may hold entries uniquely identified using an identifier OBJECT ID 302 and may be associated with a property, defined in the COLUMNS data structure 206, with the aid of an identifier herein referred to as COLUMNID 303. Further, each entry in the CHARACTERISTICS data structure may comprise a value of a given property of the particular object. As indicated by respective arrows originating from sources A and B, the CHARACTERISTICS data structure 301 may logically, directly reference the COLUMNS data structure and the OBJECTS data structure, because CHARACTERISTICS data structure 301 uses the identifiers from the respective data structures. CHARACTERISTICS data structure 301 includes a VALUE property 304, such as: black, white, red, rubber, plastic, wood, metal, axe, scythe, and hoc.

Referring to an example from FIG. 3, there are ten characteristics that may result from the premise that there are three colors, four materials and three tools. By way of a non-limiting example, one can easily recognize that the BLACK color refers to an object having ID of 1 and a property having ID of 1. By using these identifiers, for example, one may determine that the property description is “NAME” and that the object belongs to the set whose description is “COLORS”.

A fifth core data structure, RELATIONS 305, may function as an operator to hold data regarding relations present in the database. This may be a simple structure and, in principle, may hold an identifier of a relation ID 307 and additionally hold a textual description of the relation i.e., a NAME 306. As indicated by an arrow 305a , the RELATIONS data structure may logically, directly reference (e.g., downwards direction) an OBJECTS RELATIONS data structure 308, because the OBJECTS RELATIONS may use the identifiers of the relations. While only one entry is illustrated in the RELATIONS data structure, there may be a plurality of types of relations. For example, a type of relation may be indicative of a direction (e.g., unidirectional, bidirectional, etc.) of a relation.

Referring back to mind maps, for example, a relation present in the RELATIONS 305 data structure, may directly map to a branch between two nodes of a mind map. In some embodiments, as in typical mind maps, a relation may be provided with a textual description.

A sixth core data structure may be the OBJECTS RELATIONS data structure 308. This data structure may be designed to provide mapping between a relation from the RELATIONS data structure 305 and two objects from the OBJECTS data structure 201. For example, a first entry in the OBJECTS RELATIONS data structure 308 defines that a relation having identifier of 1 exists between object having an identifier of 1 and an object having an identifier of 6. This may be an exact definition that a material of wood has a color of black, which is defined across the present relational database system. OBJECT RELATIONS data structure 308 includes Object ID columns 309, Object ID column 310, and Relation ID column 311.

In some embodiments, a seventh data structure may exist in a database system. This data structure may hold data regarding relations between respective data sets and in FIG. 3 may be referred to as SETS RELATIONS 312. This data structure may function or operate to provide mapping between a relation from the RELATIONS data structure 305 and two sets from the SETS data structure 204. For example, a first entry in the SETS RELATIONS data structure 312 may define that the relation having identifier of 1 may exist between a set having an identifier of 1 and a set having an identifier of 2. Providing an entry in the SETS RELATION data structure 312 between a set having an identifier of 1 and a set having an identifier of 2 as well as between a set having an identifier of 2 and a set having an identifier of 1, may allow for creating a bidirectional relation.

There is also a possibility of self-referencing from a given set. For example, such case may be present when there is a set of persons and there exists a student—teacher relation between persons assigned to a particular set.

As described, a relational database system of tables may, in one possible example implementation, be stored in the above-described six data structures. In some instances, most of the data may be kept in the OBJECTS and CHARACTERISTICS data structures.

The data structures that are illustrated and described in FIG. 2 and FIG. 3 may also be altered in various ways. For example, in FIG. 2, the OBJECTS data structure can be partitioned or sharded according to SET ID 202. Sharding, as used herein, may generally refer to horizontal partitioning, whereby rows of database tables may be held separately rather than splitting by columns. Each partition may form part of a “shard,” wherein each “shard” may be located on a separate database server or physical location. Similarly, in FIG. 3, for example, the CHARACTERISTICS data structure can be partitioned or sharded according to COLUMN ID 303. When sharding is used, for every column in a set, the system may create key value tables that can comprise of the values from the chosen column. The OBJECT RELATIONS table can also be partitioned or sharded according to the REL. ID 311 or sharded according to an algorithm that can maintain persistence. FIGS. 2 and 3 are for illustration purposes only and may comprise of more columns than is illustrated in those figures.

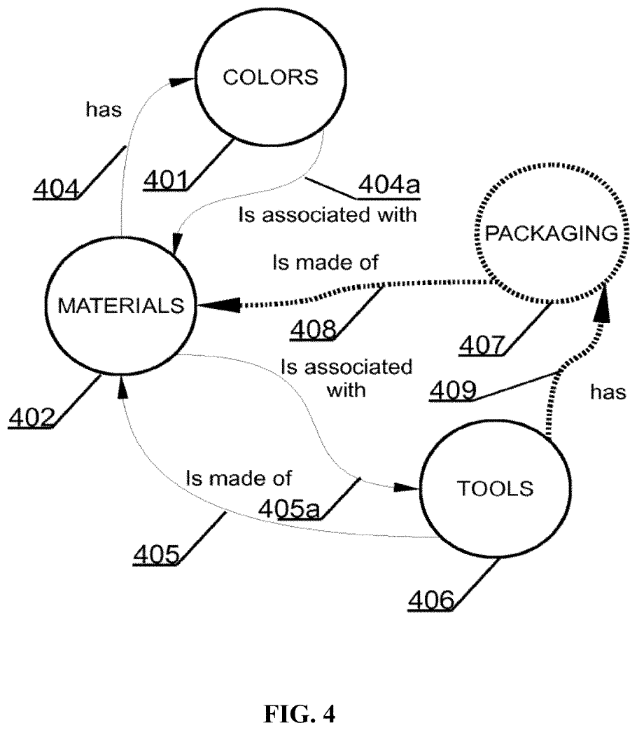

FIG. 4 depicts a mind map that may represent relationships in the database of FIG. 2. There are three nodes that may represent sets of data, namely COLORS 401, MATERIALS 402 and TOOLS 406. A mind map may additionally define branches between respective nodes. Taking into account the relational database which may be defined according to the new database system in FIGS. 2 and 3, there are four branches. A first branch 404 of the mind map is defined between COLORS 401 and MATERIALS 402 and may imply that a MATERIAL may have a COLOR. A second branch 404a of the mind map may be defined between COLORS 401 and MATERIALS 402 and may imply that a COLOR may be associated with a MATERIAL.

Similar to the first two branches, a third branch 405 of the mind map is defined between MATERIALS 402 and TOOLS 406 and may imply that that a TOOL may be made of a MATERIAL. A fourth branch 405a of the mind map may be defined between MATERIALS 402 and TOOLS 406 and may imply that a MATERIAL may be associated with a TOOL.

The relational database may be further expanded to also encompass a possibility that a TOOL may have 409 a PACKAGING 407 and the PACKAGING is made of a MATERIAL from MATERIALS 408.

In some embodiments, because all identifiers may be generated automatically, during creation of the database system of FIGS. 2-3, one may start from the mind map presented in FIG. 4. For each node, a designer may create a name of a set and properties of the objects that may be kept in the set. Similarly, the designer may create branches as relations between respective nodes, such as data sets. Based on such mind map definitions, the system of FIGS. 2-3 may be automatically generated from the mind map of FIG. 4. In particular embodiments, there may additionally be a process of assigning properties to each node of the mind map, wherein each property is an entry in the second data structure, such as the COLUMNS 206 data structure.

A database structure disclosed herein can be created by a method described as follows. A computer implemented method may store data in a memory and comprise the following blocks, operations, or actions. A first data structure may be created and stored in a memory, wherein the first data structure may comprise a definition of at least one data set, wherein each data set comprises a data set identifier and logically may hold data objects of the same type. Next, a second data structure may be created and stored in the memory, wherein the second data structure may comprise definitions of properties of objects, wherein each property may comprise an identifier of the property and an identifier of a set to which the property is assigned.

Further, a third data structure may be created and stored in the memory, wherein the third data structure may comprise definitions of objects, and wherein each object comprises an identifier and an identifier of a set the object is assigned to. A fourth data structure may be created and stored in the memory, wherein the fourth data structure may comprise definitions of properties of each object, and wherein each property of an object associates a value with an object and a property of the set to which the object is assigned. A fifth data structure may be created and stored in the memory, wherein the fifth data structure may comprise definitions of relations, and wherein each relation comprises an identifier of the relation. Finally, a sixth data structure may be created and stored in the memory, wherein the sixth data structure may comprise definitions of relations between objects wherein each objects relation associates a relation from the fifth data structure to two objects from the third data structure.

In accordance with the database system of the present disclosure (e.g., FIGS. 2-3), a process of adding an object (a record) to the database may be outlined as follows. First a new entry may be created in the OBJECTS data structure 201. The object may be assigned to a given data set defined by the SETS data structure 204. For each object property of the given set defined in the COLUMNS data structure 206, there may be created an entry in the CHARACTERISTICS data structure 301. Subsequently there may be created relations of the new object with existing objects with the aid of the OBJECTS RELATIONS data structure 308.

A method of removing objects from the database system is described below. First, an object to be removed may be identified and its corresponding unique identifier may be fetched. Next, the object entry may be removed from the OBJECTS data structure 201. The object may be removed from a given data set defined by the SETS data structure 204. Because the properties of each object are stored separately, for each object property of the given set defined in the COLUMNS data structure 206, there is removed an entry in the CHARACTERISTICS data structure 301 related to the object identifier being removed from the database. Subsequently, any existing relations of the removed object with other existing objects may be removed by deleting entries in the OBJECTS RELATIONS data structure 308 that are related to the object being removed.

A method for creating the database system using a mind map is provided. The first step may be to create a mind map structure. Defining a database system using a mind map may be beneficial and allow a designer to more easily see the big picture in very complex database arrangements. A designer may further be able to visualize the organization of data sets and relations that may exist between the respective data sets. Next, a new node may be added to the mind map structure. This may typically be executed via a graphical user interface provided to a database designer. A node of a mind map may represent a set as defined with reference to FIG. 2. Therefore, it may be advantageous at this point to define, preferably using the graphical user interface, properties associated with the data set associated with this particular node of the mind map. Then, a record or entry may be stored in the first and second data structures, which are the SETS data structure 204 and COLUMNS data structure 206 of FIG. 2, respectively.

The next step may be to create a branch within the mind map. A branch may start at a node of the mind map and end at the same node of the mind map to define a self-relation. For example, there may be a set of users for which there exists a hierarchy among users. Alternatively or in addition to, a branch may start at a node of the mind map and end at a different node, for example, of the mind map to define a relation between different nodes, i.e., different sets of objects of the same kind.

The following operations may be executed to store a record in the fifth data structure, which is the RELATIONS data structure 305 of FIG. 3. At least one object can be added to existing data sets, i.e., nodes of the mind map. In some embodiments, a way of adding objects to mind map nodes may be by way of a graphical user interface with one or more graphical elements representing nodes and connections among the nodes. For example, by choosing an option to add an object, a user may be presented with a set of properties that may be set for the new object. The properties may be defined in the COLUMNS data structure 206 of FIG. 2. After the user provides an input, an object may be added to the selected node of the mind map by storing one or more records in the third, fourth, and sixth data structures that are the OBJECTS data structure 201, the CHARACTERISTICS data structure 301 and OBJECTS RELATIONS data structure 308 of FIGS. 2 and 3, respectively.

Databases of the present disclosure may store data objects in a non-hierarchical manner. In some cases, such databases may enable database queries to be performed without the need of joins, such as inner or outer joins, which may be resource intensive. This may advantageously improve database queries.

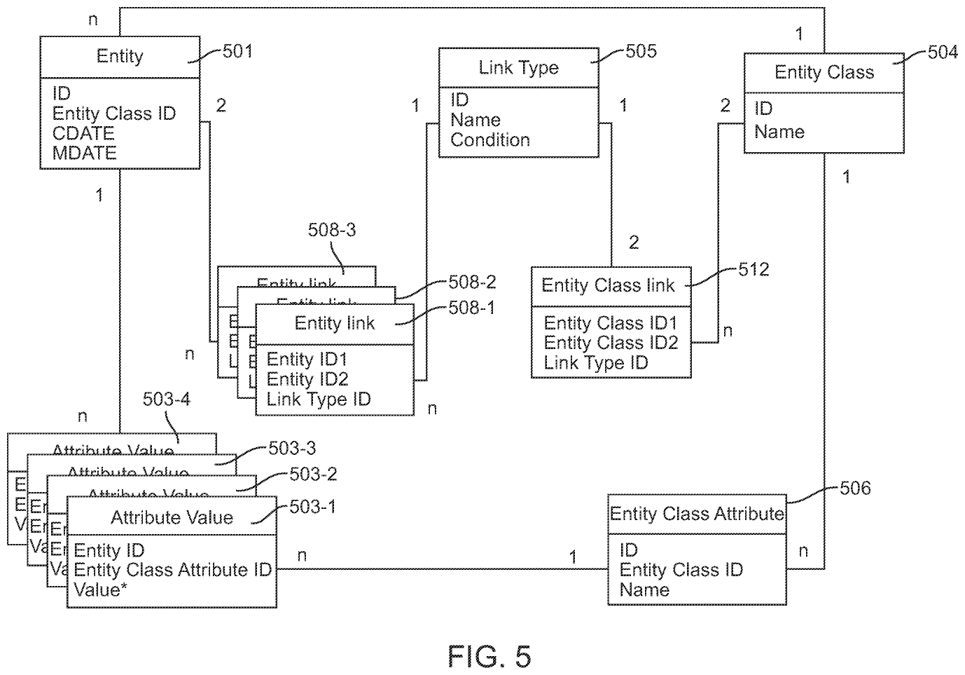

FIG. 5 shows an exemplary model of a database system of the present disclosure. The model may be similar to, or correspond to, the examples of the database systems described in FIG. 2 and FIG. 3. The model may comprise a set of predefined data structures. In the illustrated model, the Entity data structure 501 may correspond to the OBJECTS data structure 201 as described in FIG. 2. Similarly, the Entity data structure may hold entries uniquely identified with an identifier ID (e.g., ID) and associated with an entity class, defined in the Entity Class data structure 504, with the aid of an identifier herein called Entity Class ID. The Entity data structure 501, in some embodiments, may further comprise a timestamp corresponding to the date and time an object is created (e.g., CDATE) and/or date and time an object is last modified (e.g., MDATE).

The Entity Class data structure can correspond to the SETS data structure 204 as described in FIG. 2. Similarly, the Entity Class data structure may hold data related to Entity Class data. Classes of data may be represented on a mind map as nodes. Each entry in an Entity Class data structure 504 may comprise at least a unique identifier (e.g., ID) and may also comprise its name (e.g., Name). For each entity property of the given entity class defined in the Entity Class Attribute data structure 506, there may be created an entry in the Attribute Value data structure 503-1, 503-2, 503-3, 503-4. Subsequently there may be created relations of the new object with existing objects with the aid of the Entity Link data structure 508-1, 508-2, 508-3.

The Entity Class Attribute data structure 506 can correspond to the COLUMNS data structure 206 as described in FIG. 2. Similarly, the Entity class Attribute data structure 506 may hold entries uniquely identified with an identifier ID (e.g., ID) that is associated with an entity class, defined in the Entity Class data structure 504, with the aid of the Entity Class ID, and the name of the attribute (e.g., Name). The Attribute Value data structure 503-1, 503-2, 503-3, 503-4 may correspond to the CHARATERISTICS data structure 301 as described in FIG. 3, except that the

Attribute Value data structure may use multiple tables 503-1, 503-2, 503-3, 503-4 to hold entries uniquely identified using an identifier (e.g., Entity ID), a property defined in the Entity class Attribute data structure 506, with the aid of an identifier (Entity Class Attribute ID) and a value of a given property of the particular entity (e.g., Value). In some cases, the multiple tables may collectively hold the attribute values with each table storing a portion of the data.

The Entity Link data structure 508-1, 508-2, 508-3 can correspond to the OBJECTS RELATIONS data structure 308 as described in FIG. 3 with the exception that multiple tables 508-1, 508-2, 508-3 may be used to collectively hold data related to relations or connections between two entities. Similarly, an entry of the Entity Link data structure may comprise two entity IDs (e.g., Entity ID1, Entity ID2) and the identifier of the Link Type (e.g., Link Type ID) between the two entities. The Link Type identifier may reference from the Link Type data structure 505.

The Link Type data structure 505 can correspond to the RELATIONS data structure 305 as described in FIG. 3. Similarly, the Link Type data structure 505 may hold an identifier of a link type ID (e.g., ID) and additionally hold a textual description of the link (e.g., NAME). In some cases, the link type can define a permission level of accessing the connection between entities or entity classes. For example, the link type may be a private type link that only the user who creates the link or the system administer can view or modify, or a public type link that can be viewed or defined by any user. For instance, an administrator or certain users with privileges may configure a link to be visible to other users. In this case, the administrator may decide to “publish” the link, which may enable the link to be available to the public, thereby converting the link type from private to public. Alternatively or in addition to, a link type may have various other permission levels or editable privileges that are provided by the system.

Examples of visualized databases and search path

Methods of the present disclosure may include use of data objects. A data object stored in a data structure may be linked with another data object in the same data structure or in another data structure. However, the two data objects may be related to a single abstract class. For example, an enterprise may have multiple clients, and each client may have an identifier, a purchased product, and billing information. In a database, a client identifier and a purchased product may be placed together in a structure of a sale, but a client identifier and billing information may be organized into a structure of finance. However, an abstract class representing a client may aggregate an identifier, a purchased product, and billing information. In some embodiments, a database can be visualized as a graph with each entity class depicted as a node and connections between classes depicted as links. An interactive breadcrumb associated with an analysis or search path may be presented to a user on a user interface (UI) along with the graph. Beneficially, a visualized graph may allow a user to see a big picture of aggregated data objects in terms of abstract classes without going into the details of data objects.

The user interfaces may be displayed, for example, via a web browser (e.g., as a web page), a mobile application, and/or a standalone application. In some embodiments, the user interfaces shown may also be displayed on any suitable computer device, such as a cell/smart phone, tablet, wearable computing device, portable/mobile computing device, desktop, laptop, or personal computer, and are not limited to the examples as described herein. In some cases, multiple user interfaces may be switchable. A user may switch between different user interfaces than illustrated here. The user interfaces and functionality described herein may be provided by software executing on the individual's computing device, by a data analysis system located remotely that is in communication with the computing device via one or more networks, and/or some combination of software executing on the computing device and the data analysis system. In some embodiments, analogous interfaces may be presented using audio or other forms of communication. In some embodiments, the interfaces may be configured to be interactive and respond to various user interactions. Such user interactions may include clicking or dragging with a mouse, manipulating a joystick, typing with a keyboard, touches and/or gestures on a touch screen, voice commands, physical gestures made in contact or within proximity of a user interface, and the like.

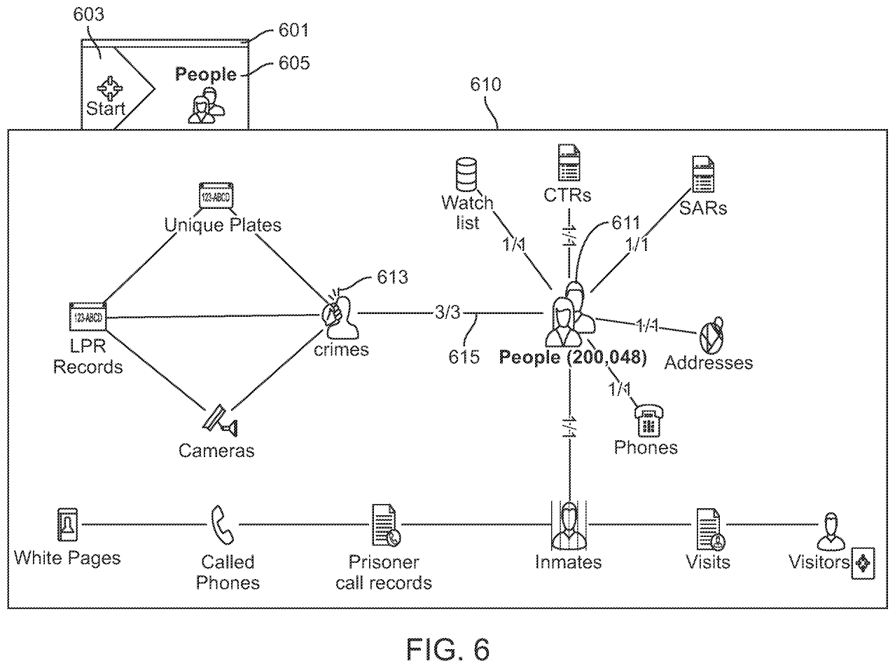

FIG. 6 shows an example of a visualized database 610 and the start of a breadcrumb 601. Each class (e.g., people) can be visualized as a graph node. In the illustrated example, a class may include, but is not limited to, People 611, crimes 613, watch list, CTRs, SARs, Addresses, Phones, Inmates, Visits, Visitors, Prisoner Call records, Called Phones, White Pages, Cameras, Unique Plates, and LPR Records. Further, such visualized classes may be linked. A link (for instance, link 615 between People 611 and crimes 613) may be a representation of a link of underlying data objects or entities. In some applications, a link can mean a JOIN command in a database. In some cases, a visualized link may comprise an assigned link type; in other words, a link may be further associated with a meaning beyond merely a join.

A breadcrumb 601 may be presented to a user along with the visualized database 610. The breadcrumb may be generated as a user explores the database, for example, in real-time. In the illustrated example, a user may select a People entity class for further analysis, such that a graphical element comprising a target icon 603 and text 605 (“People”) associated with the selected entity class may be displayed as a crumb of the breadcrumb. In some cases, a breadcrumb may start with selecting a class for investigation or analysis.

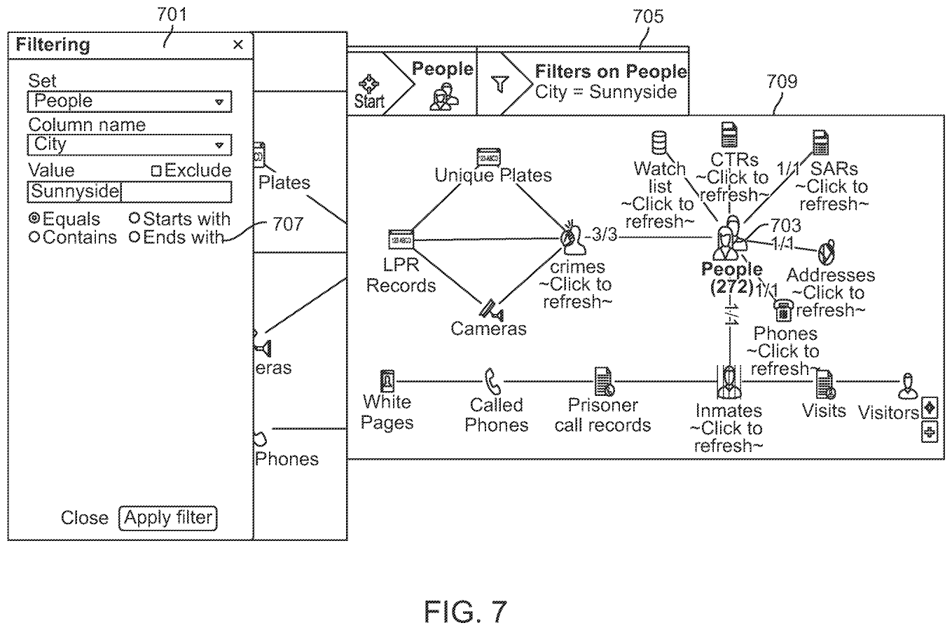

FIG. 7 shows an example of performing a filter operation on a selected class and the associated breadcrumb. As shown in the example, a user may be provided with a filtering interface or panel 701 to input search criteria for a filter option by clicking on the People class 703 in the visualized database 709 or by clicking on the People crumb in the breadcrumb 705. As mentioned elsewhere herein, an entity class can be filtered by one or more Entity Class Attributes. In an example, the user can select the People entity class, then filter the selected entity class by Entity Class Attribute with name ‘City’ and Attribute Values with ‘Sunnyside.’ In some embodiments, multiple search rules or mathematical rules 707 may be provided to a user for defining the filter criteria on Attribute Values. For example, a user may input the value (e.g., Sunnyside), then select from the options of “Equals”, “Starts with”, “Contains” and “Ends with” for further specifying the search criteria. Other search rules or mathematical rules such as greater than, lower than, in, range or the like may be used to specify the search criteria.

In some embodiments, upon receiving filter criteria from a user via the filtering interface 701 and/or the visualized database 709, the breadcrumb 705 may be updated to reflect the associated search result and/or filter operations. For example, a user may select (e.g., click) the “Apply filter” button on the filtering interface 701 indicating submission of a query request, and in response to the query request, the breadcrumb 705 may be updated to show the filter criteria (e.g., City=Sunnyside, filters on People) to reflect the set, column name, and value that have been selected and set by the user. Alternatively or additionally, the breadcrumb may be updated in real time as a user inputs the search criteria. In some cases, the visualized database 709 may be updated to show the search result in response to the user submitting a query request. For instance, by selecting the “Apply filter” button on the filtering interface, the search result (e.g., “People 272” may mean 272 People entities are in the result table) may be updated and displayed on the visualized database. Alternatively, the search result may be displayed upon a user selecting the People icon 703 on the visualized database. As described above, the search result may be saved in a temporary table.

In some cases, the filtering interface or filtering panel 701 may pop up or open up upon receiving a user input. For example, a user may click on an entity set representation on the visual database interface and bring up the filtering interface may selecting a filter operation option. In the case of modifying an existed a query operation, a user may click on a graphical element of the breadcrumb and the corresponding filtering interface 701 may pop up accordingly. In some cases, the filtering interface may automatically hide from being viewed by the user upon receiving a user input (e.g., clicking on the “Apply filter” button).

In some embodiments, multiple Entity Class Attributes or Columns can be selected in a query step. A user may select more than one Entity Class Attributes and specify the respective Attribute values in a query step. In some cases, a user may specify a logical relationship between these multiple Entity Class Attributes. For example, a user may define a logical relationship between the multiple Entity Class Attributes by selecting from “and,” “or,” or other customer-defined relationships.

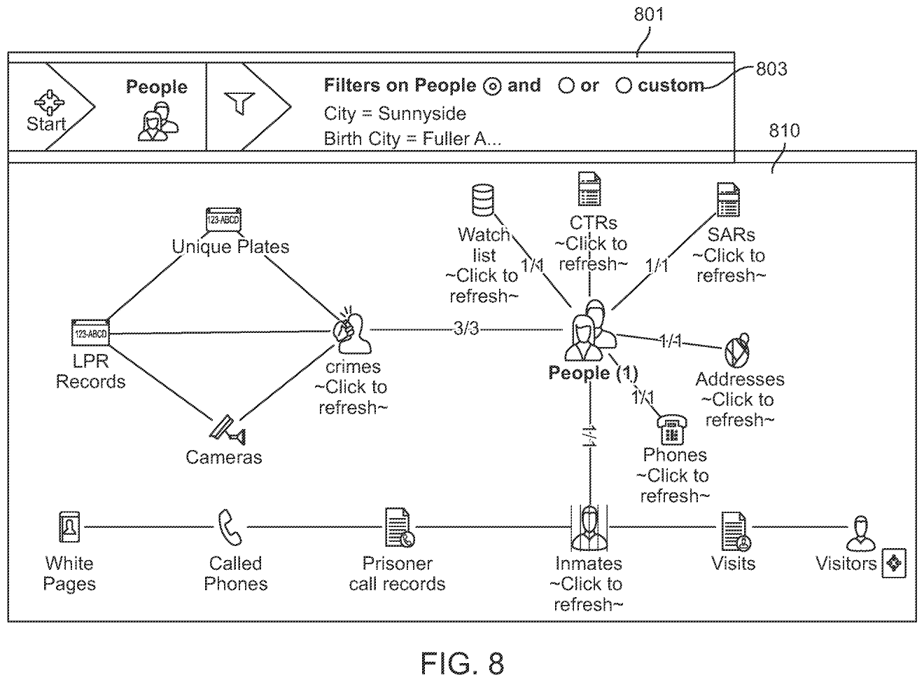

The breadcrumb may comprise interactive graphical elements such that a user may modify and adjust one or more parameters or filter criteria by interacting with the breadcrumb directly. One or more parameters of a query or filtering operation can be set via the interactive graphical element directly. For example, a user may define the logical relationship among multiple Entity Class Attributes by interacting with the breadcrumb. FIG. 8 shows an example of determining multiple Entity Class Attributes and logical relationships in a breadcrumb 801. A user may select multiple Entity Class Attributes or Columns, and set respective Value using the same filter interface as described in FIG. 7. As illustrated in the example of FIG. 8, upon receiving the query request from the user, the breadcrumb 801 may be updated to show the multiple Entity Class Attributes (e.g., City=Sunnyside, Birth City=Fuller A . . . ). In some embodiments, a user may specify the logical relationship among the multiple Entity Class Attributes via the breadcrumb. For instance, a user may be provided with logical relationship options 803 (e.g., and, or, customer) in the breadcrumb to select. A user may be allowed to define a logical relationship in addition to the options provided by the system. For example, the customer option may allow a user to define logical relationships for more than two Entity Class Attributes. For instance, a user may define the logical relationship for three Entity Class Attributes as: (A and B) or C. The logical relationship options can be provided in any suitable manner such that a user may set the logical relationship by interacting directly with the breadcrumb. For example, the logical relationship options can be provided via a menu (e.g., dropdown menu), via selectable table and other user interface features. Alternatively or additionally, the logical relationship can be specified via the filtering interface as shown in FIG. 7. In some embodiments, a user may return back to a previous step and modify the logical relationship. The search result may then be updated accordingly in the visualized database 810.

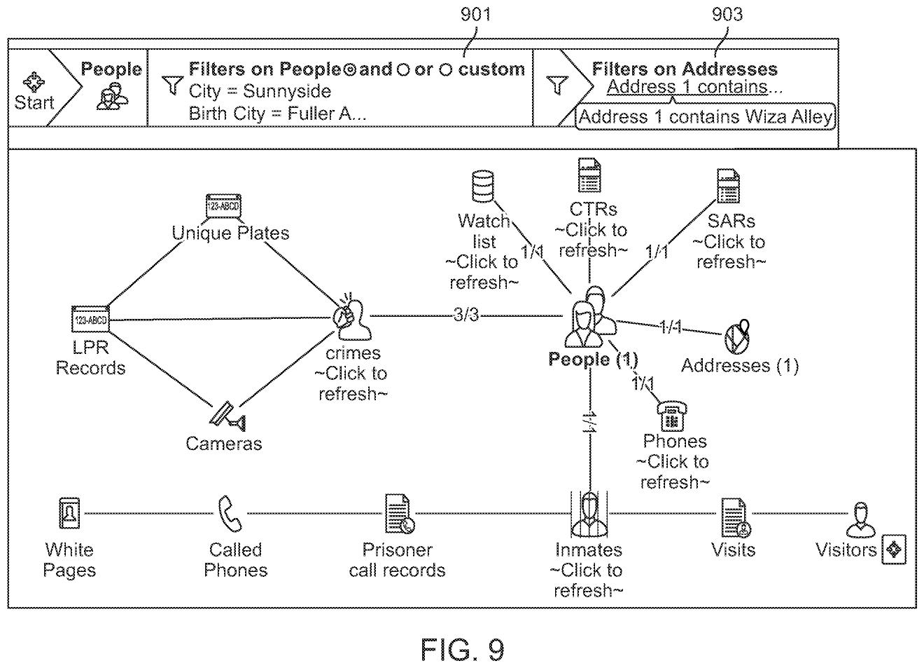

FIG. 9 shows an example of a breadcrumb comprising filters on different entity classes or data sets. As shown in the example, following the filter operation on the People entity class, a user may create a new step 903 including a filter on a connected entity class (e.g., Addresses). Similarly, a use may specify the filter criteria such as filtering on Address containing Wiza Alley in the same manner as described above.

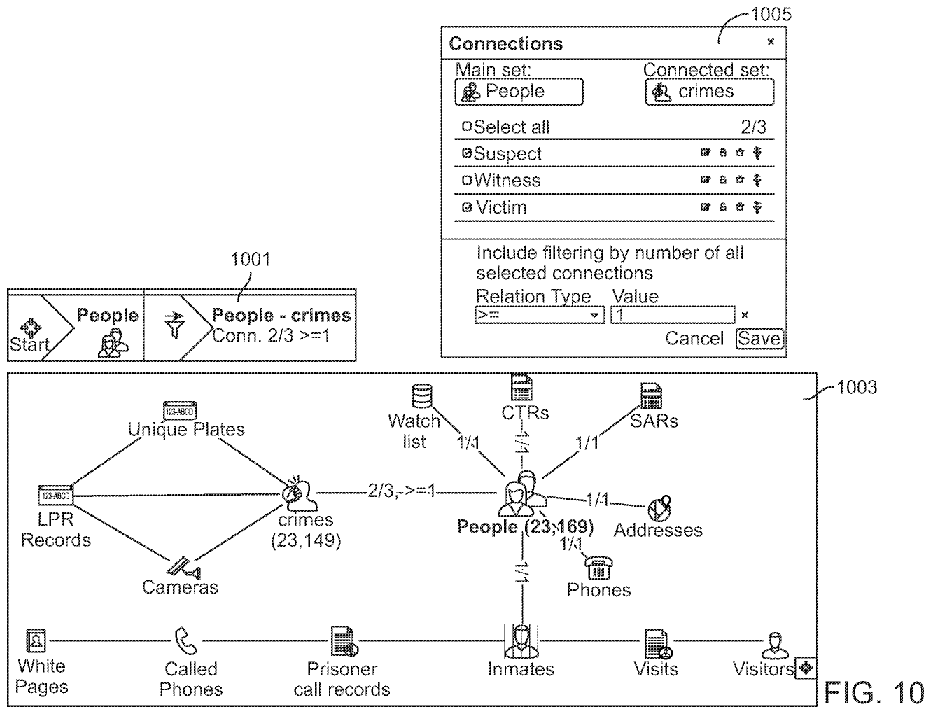

FIGS. 10-13 show examples of a breadcrumb comprising a filter operation on Entity Links or connections. A set of objects may be filtered on the entity links, such as the number of connections or links. As shown in FIG. 10, a user may specify the connection filter criteria via a connections interface 1005. A user may select the entity class to be filtered on (e.g., main set) and the connected set (e.g., connected set). The user may also be allowed to select one or more of the connections or links between the selected main set and connected set. A main set can also be referred to as a target set. The user may then determine the number of connections for filtering by specifying the mathematical rule (e.g., relation type such as >, <, =, >=, <=) and the number (e.g., Value). The user may be allowed to determine the number of total connections between the selected entity classes or data sets. Alternatively or additionally, the user may determine the number of connections for each individual, selected connection. As shown in the example of FIG. 10, the user may select People as the main set and crimes as the connected set indicating People is the target set to be filtered by the connections between People and crimes. In some embodiments, upon selecting the entity classes or data sets (e.g., People and crimes), all the connection(s) between the selected data sets may be provided to the user for selection. In the illustrated example, there are three connections, Suspect, Witness and Victim, between People and crimes and the user has selected the Suspect and Victim connections. The illustrated examples in FIG. 10 shows that the user may then specify the number of all selected connections as a search criteria (e.g., >=1) such that upon receiving the filter request (e.g., clicking on the save button in the connections interface 1005), a search result comprising entities in the People class that has at least one connection (Suspect or Victim) are generated and/or stored in a temporary table. Upon receiving the filter request, a new crumb 1001 may be generated including the associated search criteria (e.g., Conn.2/3;>=1 indicating two out three connections are selected with value being at least one). In some cases, the search result may be automatically displayed in the visualized database 1003 (e.g., 23,169 entities in People are in the search result). Alternatively or additionally, the search result may be updated upon a user selecting the People icon in the visualized database 1003.

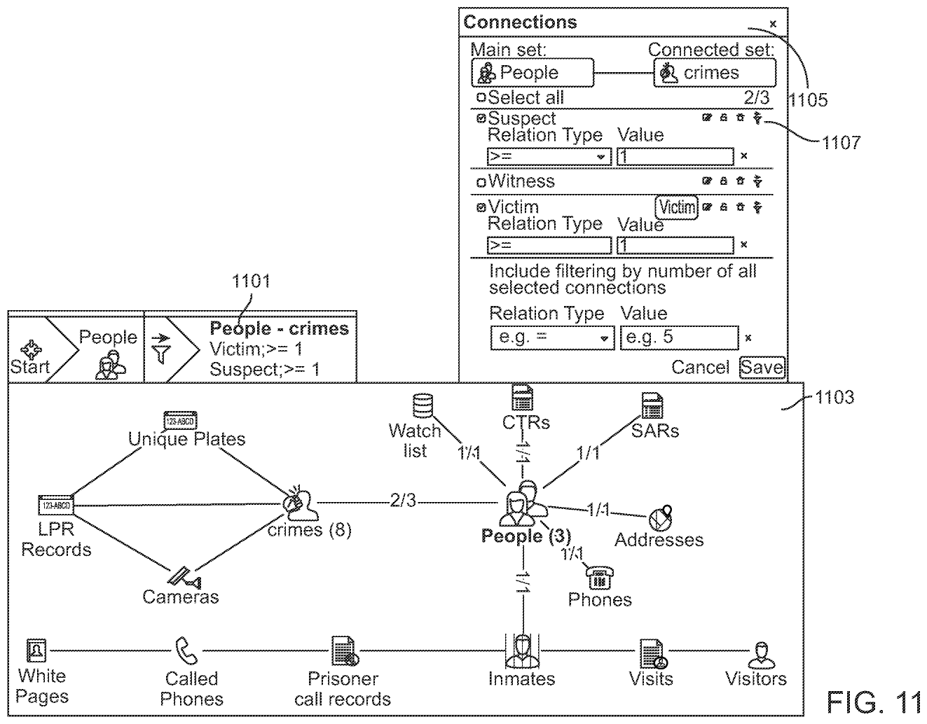

FIG. 11 shows another example of filtering on connections between entity classes. As mentioned above, a user may determine the number of connections for each individual, selected connection. As shown in the example, a user may specify, via the Connections interface 1105, the mathematical rule (e.g., >=) and value (e.g., 1) for the Suspect connection and the Victim connection respectively. Each individual link can be edited (e.g., delete, edit, publish, filter) by the user using the functions 1107. For instance, a user may select the trash can icon next to Suspect to delete this connection, select the lock icon to publish a private ink, or select the edit icon to modify the Relation Type and/or Value as the search criteria. Various other functions may be applied to modify or edit a link. For instance, a user may enable/disable the editing function of a selected link. In the illustrated example, the search result displayed in the visualized database 1103 shows three entities in People with each entity having at least a Suspect connection and at least a Victim connection to the crimes.

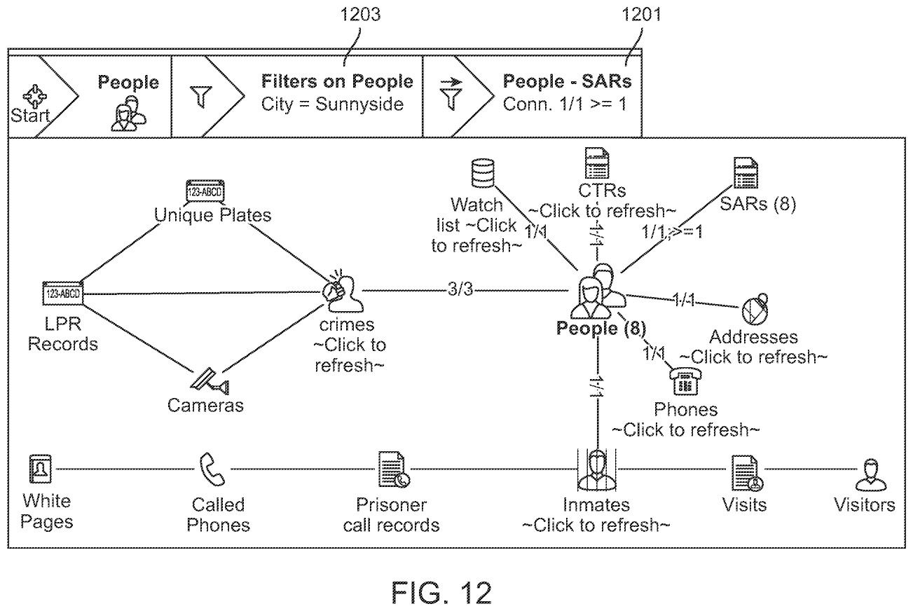

FIG. 12 shows an example of a breadcrumb comprising a filter operation on connections. Filtering on a connection can be performed after any operations. In this example, following the filter of People on the City attribute 1203, a further filtering of the People class on connections between People and SARs is performed 1201. In some embodiments, the step of filtering on an attribute and the step of filtering on a connection may use different icons, indicating different type of operations. As shown in FIG. 12, filtering on attributes of entity class crumb 1203 may use a funnel icon whereas filtering on connections crumb 1201 may user an arrow and funnel icon.

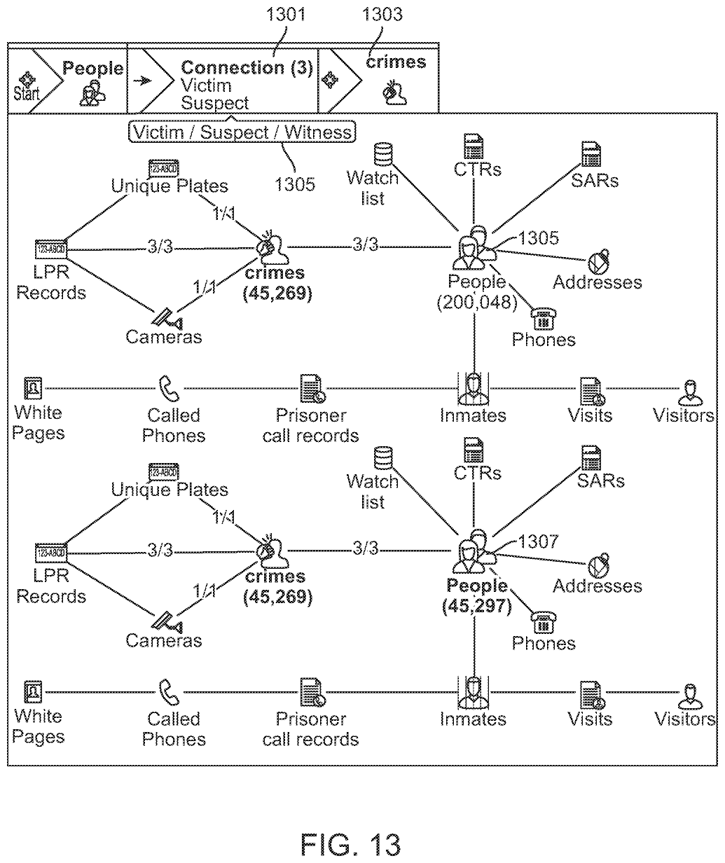

FIG. 13 shows an example of a breadcrumb comprising a filter operation on connections. In the breadcrumb, the target set need not be in a preceding crumb of a connected set. A data set or entity class in any location of a breadcrumb can be set as a target set for filtering. In the illustrated example, the target class or target set is crimes 1303 which is filtered on connections to People set. A user may specify the connection filtering criteria in the same manner as described elsewhere herein. In the example, there are three connections between People and crimes. The search result may comprise entities from crimes, each of which has all three connections (e.g., victim, suspect, witness) to the People set. In some cases, search-related information may not be fully displayed in a crumb. As shown in the example, only ‘victim’ and ‘suspect’ are shown in the connection crumb 1301. The full information may be displayed in a bubble 1305 triggered by a user action (e.g., click on the connection crumb or cursor hanging over the crumb). As shown in the example, the search result (e.g., crimes 45,269) may be displayed in the visualized database upon the user generating the filter request. In some cases, a user may be allowed to view the entities of the connected set associated with the search result. In some cases, the connected set 1305 (e.g., People 200,048) may not be updated automatically. A user may need to select the connected set, such as the People icon, in order to see the entities of People that are associated with the crimes having all three connections 1307 (e.g., People 45,297). Alternatively or additionally, the connected set may be automatically updated concurrently with updating the result of the target set.

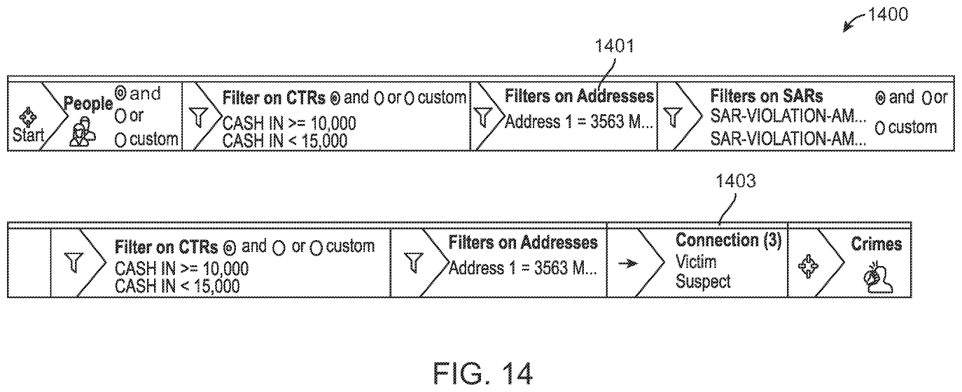

FIG. 14 shows an example of a breadcrumb 1400. In some cases, a breadcrumb 1400 may be extended for as long as a user explores the data set. In some cases, the breadcrumb may be extended for as long as the breadcrumb may not be displayed fully in the user interface (UI). For example, as the breadcrumb grows longer, only the end portion of the breadcrumb may be displayed on the UI. However, a user may navigate back and forth in the UI (e.g., via scrolling) to view or modify any step of the breadcrumb. In the illustrated example, the user may return back to the filters on an addresses step 1401 and perform filtering of the crimes on connections in a new step 1403. In some cases, the breadcrumb may be color-coded to indicate that a target set is selected.

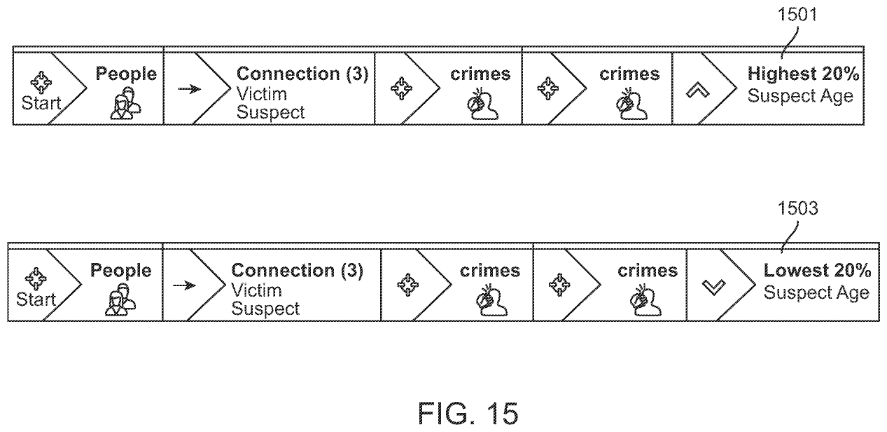

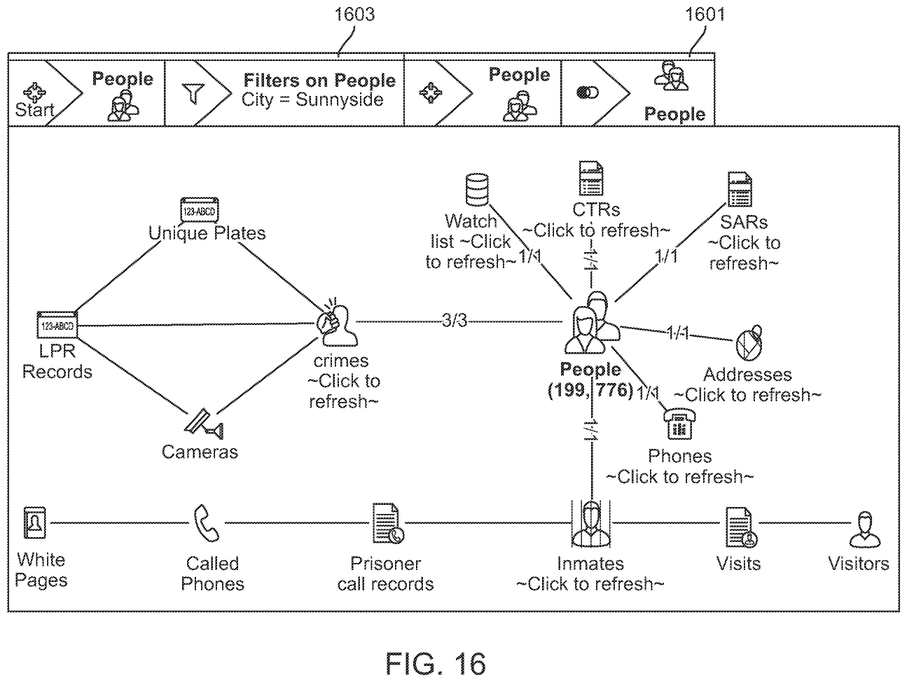

FIG. 15 and FIG. 16 show examples of a breadcrumb comprising a step for analyzing a search result. As mentioned above, a breadcrumb may comprise operations for sorting, ranking, and/or selecting at least a subset of the search result. For example, operations may be applied to a prior search result to rank or sort the search result based on a user-selected or user-defined rule. The rules may include, for example, ranking low to high, ranking high to low, highest 20%, lowest 30%, and the like. The operations may allow a user to select to view a subset of the search result based on any user-defined rule. For instance, a user may select to view a complementary set of previous search results. A complementary set of search results may refer to a selected subset that is the remaining entities of the target class that are not included in the previous search result. FIG. 15 shows examples of ordering the search result (i.e., entities in crimes) by suspect age with the highest 20% 1501 and lowest 20% 1503. FIG. 16 shows examples of performing an operation 1601 to select the complementary data set of the previous search result 1603 (i.e. Filters on People by City=Sunnyside). The generated result of the operation 1601 is not included in the previous search result 1603.

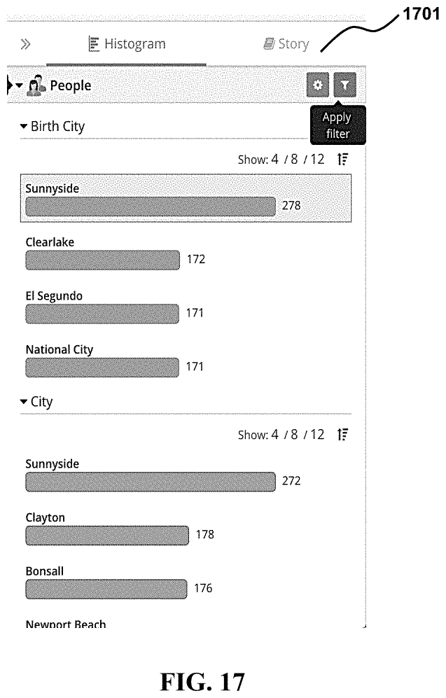

In some embodiments, a search result, any intermediate search result, or analysis result can be displayed on the visualized database and/or on a separate result interface. FIG. 17 shows an example of a result interface 1701. The result interface 1701 may provide one or more visual or graphical representations for a user to view and further analyze the result. The visual or graphical representations may include, but are not limited to, tables, bar charts, pie charts, histograms, line charts, textual representations (e.g., numbers, text), multimedia representations (e.g., audio and/or video clips), and the like. A user may be allowed to edit the one or more visual or graphical representations via the result interface 1701. For instance, a user may select to view the search result organized by attributes/properties, individual entities ranked according to a user selected attribute/property, and the like. A user may switch between different visual or graphical representations. In other embodiments, the user may be allowed to select between two different display styles than illustrated here (e.g., between pie chart and bar chart) or among more than two display styles. For instance, a user may switch the display style or display format from the histogram display to a tabular display. As shown in FIG. 17, a histogram format is provided to show a search result of filtering a People set on Birth City and City. For each attribute (i.e., Birth City, City), the attribute values are ranked by the number of counts and the higher ranked attribute and numbers are displayed. A user may customize or define the sorting/ranking rule via the result interface 1701. In some cases, the result interface 1701 may further provide a filtering function for a user to build a new filter operation in a breadcrumb.

Methods and systems of the present disclosure may be combined with other methods and systems, such as those described in U.S. patent application Ser. No. 14/222,795, filed Mar. 24, 2014, U.S. patent application Ser. No. 14/315,481, filed Jun. 26, 2014, U.S. patent application Ser. No. 14/469,958, filed Aug. 27, 2014, and U.S. patent application Ser. No. 14/469,968, filed Aug. 27, 2014, each of which is entirely incorporated herein by reference. Such methods and systems, for example, may be used with methods and systems of the present disclosure to store data as a mind map in a relational database system.

### Computer Systems

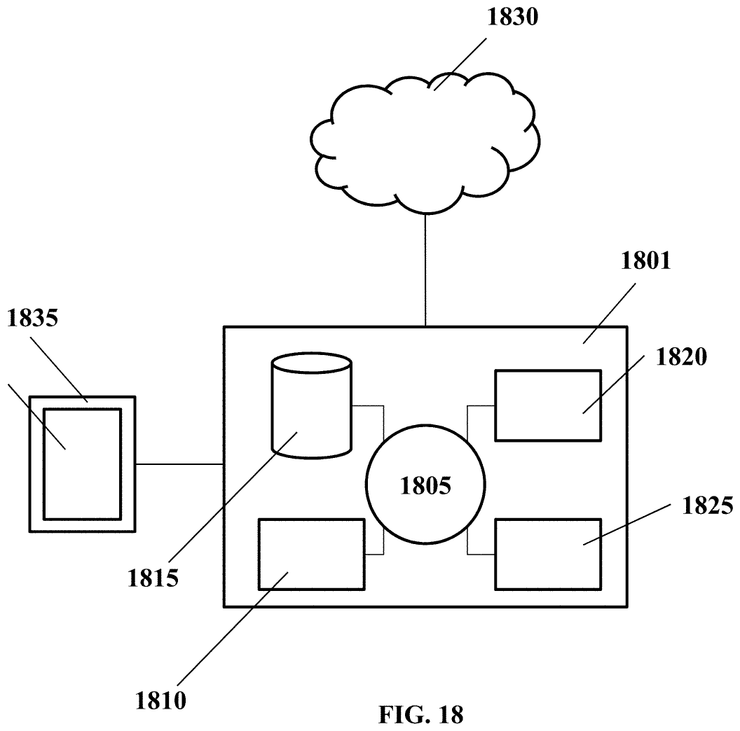

The present disclosure provides computer systems that are programmed to implement methods of the disclosure. FIG. 18 shows a computer system 1801 that is programmed or otherwise configured to generate an interface for a search path or interactive breadcrumb. The computer system 1801 can regulate various aspects of visualization, queries and graph analysis of the present disclosure, such as, for example, generating graphs of business classes and performing queries on selected classes. The computer system 1801 can be an electronic device of a user or a computer system that is remotely located with respect to the electronic device. The electronic device can be a mobile electronic device.

The computer system 1801 includes a central processing unit (CPU, also “processor” and “computer processor” herein) 1805, which can be a single core or multi core processor, or a plurality of processors for parallel processing. The computer system 1801 also includes memory or memory location 1810 (e.g., random-access memory, read-only memory, flash memory), electronic storage unit 1815 (e.g., hard disk), communication interface 1820 (e.g., network adapter) for communicating with one or more other systems, and peripheral devices 1825, such as cache, other memory, data storage and/or electronic display adapters. The memory 1810, storage unit 1815, interface 1820 and peripheral devices 1825 are in communication with the CPU 1805 through a communication bus (solid lines), such as a motherboard. The storage unit 1815 can be a data storage unit (or data repository) for storing data. The computer system 1801 can be operatively coupled to a computer network (“network”) 1830 with the aid of the communication interface 1820. The network 1830 can be the Internet, an internet and/or extranet, or an intranet and/or extranet that is in communication with the Internet. The network 1830 in some cases is a telecommunication and/or data network. The network 1830 can include one or more computer servers, which can enable distributed computing, such as cloud computing. The network 1830, in some cases with the aid of the computer system 1801, can implement a peer-to-peer network, which may enable devices coupled to the computer system 1801 to behave as a client or a server.

The CPU 1805 can execute a sequence of machine-readable instructions, which can be embodied in a program or software. The instructions may be stored in a memory location, such as the memory 1810. The instructions can be directed to the CPU 1805, which can subsequently program or otherwise configure the CPU 1805 to implement methods of the present disclosure. Examples of operations performed by the CPU 1805 can include fetch, decode, execute, and writeback.

The CPU 1805 can be part of a circuit, such as an integrated circuit. One or more other components of the system 1801 can be included in the circuit. In some cases, the circuit is an application specific integrated circuit (ASIC).

The storage unit 1815 can store files, such as drivers, libraries and saved programs. The storage unit 1815 can store user data, e.g., user preferences and user programs. The computer system 1801 in some cases can include one or more additional data storage units that are external to the computer system 1801, such as located on a remote server that is in communication with the computer system 1801 through an intranet or the Internet.

The computer system 1801 can communicate with one or more remote computer systems through the network 1830. For instance, the computer system 1801 can communicate with a remote computer system of a user (e.g., a webserver, a database server). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 1801 via the network 1830.

Methods as described herein can be implemented by way of machine (e.g., computer processor) executable code stored on an electronic storage location of the computer system 1801, such as, for example, on the memory 1810 or electronic storage unit 1815. The machine executable or machine readable code can be provided in the form of software. During use, the code can be executed by the processor 1805. In some cases, the code can be retrieved from the storage unit 1815 and stored on the memory 1810 for ready access by the processor 1805. In some situations, the electronic storage unit 1815 can be precluded, and machine-executable instructions are stored on memory 1810.

The code can be pre-compiled and configured for use with a machine have a processor adapted to execute the code, or can be compiled during runtime. The code can be supplied in a programming language that can be selected to enable the code to execute in a pre-compiled or as-compiled fashion.

Aspects of the systems and methods provided herein, such as the computer system 1801, can be embodied in programming. Various aspects of the technology may be thought of as “products” or “articles of manufacture” typically in the form of machine (or processor) executable code and/or associated data that is carried on or embodied in a type of machine readable medium.

Machine-executable code can be stored on an electronic storage unit, such memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 1801 can include or be in communication with an electronic display 1835 that comprises a user interface (UI) 1840 for providing, for example, visualization. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 1805.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

What is claimed is:

1. A computer-implemented method for performing data analysis in a relational database, comprising:
(a) bringing an electronic device of a user in communication with a computer server comprising said relational database that stores data objects in a non-hierarchical manner, which electronic device comprises a user interface;
(b) receiving a request from said user via said user interface to perform a task directed to at least a subset of said data objects;
(c) generating one or more filtering operations for said task, which one or more filtering operations is stored in a memory unit and, upon execution, generates a filtered data set from said at least said subset of said data objects; and
(d) automatically generating a search path comprising a plurality of visual graphical elements on said user interface, wherein at least one of said visual graphical elements corresponds to said one or more filtering operations performed on said at least said subset of said data objects.

2. The method of claim 1, wherein said one or more filtering operations are selected from the group consisting of: filter on a property of a selected data object, filter on the number of selected relationships between selected data sets of said data objects, a complement operation of a previous filter operation, and select a subset of sorted search results.

3. The method of claim 2, wherein said complement operation of a previous filter operation provides complementary search results of said previous filter operation.

4. The method of claim 1, wherein said at least one of said visual graphical element comprises options for determining a logical relationship of said one or more filtering operations.

5. The method of claim 4, further comprising updating search result in response to a change of said logical relationship of said one or more filtering operations.

6. The method of claim 1, further comprising outputting search result in a histogram view or in a graph.

7. The method of claim 6, wherein said graph comprises one or more nodes and one or more links representing said data sets of said data objects and relationships between said data sets.

8. The method of claim 1, further comprising updating search result in response to adding or removing a visual graphical element of said plurality of visual graphical elements.

9. The method of claim 1, further comprising reproducing a search result by applying said stored one or more filtering operations to said data objects.

10. The method of claim 1, wherein storing said data objects in said non-hierarchical manner comprises storing said data objects in defined fixed data structures, wherein said defined fixed data structures comprise:
a first data structure, stored in a memory, comprising a definition of data sets in said relational database, wherein a definition of a data set comprises a unique data set identifier and a set name;
a second data structure, stored in said memory, comprising definitions of properties of objects in said relational database, wherein a definition of a property comprises a unique identifier of said property and a data set identifier, from said first data structure, said property is assigned to;
a third data structure, stored in said memory, comprising definitions of objects of said data sets in said relational database, wherein a definition of an object comprises a unique object identifier and a data set identifier, from said first data structure, said object is assigned to;
a fourth data structure, stored in said memory, comprising definitions of object values of said data sets in said relational database, wherein a definition of object value comprises an object identifier, from said third data structure, and a property of said data set, from said second data structure, said object value being assigned to;
a fifth data structure, stored in said memory, comprising definitions of relations of data sets in said relational database, wherein a definition of a relation comprises a unique identifier of said relation and a name of said relation; and
a sixth data structure, stored in said memory, comprising definitions of objects relations between said objects in said relational database, wherein a definition of an object relation associates a relation, from said fifth data structure, with two object identifiers from said third data structure.

11. The method of claim 10, wherein said defined fixed data structures further comprise a seventh data structure, stored in said memory, comprising definitions of set relations between data sets in said relational database, wherein a definition of a set relation associates a relation, form said fifth data structure, with two set identifiers from said first data structure.

12. A system for performing data analysis in a relational database comprising:
a relational database that stores data objects in a non-hierarchical manner; and
one or more computer processors operatively coupled to said relational database, wherein said one or more computer processors are individually or collectively programmed to:
(i) receive a request from a user via a user interface to perform a task directed to at least a subset of said data objects;
(ii) generate one or more filtering operations for said task, which one or more filtering operations is stored in a memory unit and, upon execution, generates a filtered data set from said at least said subset of said data objects; and
(iii) automatically generate a search path comprising a plurality of visual graphical elements on said user interface, wherein at least one of said visual graphical elements corresponds to said one or more filtering operations performed on said at least said subset of said data objects.

13. The system of claim 12, wherein said one or more filtering operations are selected from the group consisting of: filter on a property of a selected data object, filter on the number of selected relationships between selected data sets of said data objects, a complement operation of a previous filter operation, and select a subset of sorted search results.

14. The system of claim 13, wherein said complement operation of a previous filter operation provides complementary search results of said previous filter operation.

15. The system of claim 12, wherein said at least one of said visual graphical element comprises options for determining a logical relationship of said one or more filtering operations.

16. The system of claim 12, where said one or more computer processors are programmed to further output search result in a histogram view or in a graph.

17. The system of claim 16, wherein said graph comprises one or more nodes and one or more links representing said data sets of said data objects and relationships between said data sets.

18. The system of claim 12, where said one or more computer processors are programmed to further update search result in response to adding or removing a visual graphical element.

19. The system of claim 12, where said one or more computer processors are programmed to further store said one or more filtering operations and criteria in the memory unit, wherein said criteria are inputted via said user interface.

20. The system of claim 19, where said one or more computer processors are programmed to further reproduce a search result by applying said stored one or more filtering operations and criteria to said data objects.
